(19) United States
(12) Patent Application Publication
(10) Pub. No.: US 2010/0325338 A1
(43) Pub. Date: Dec. 23, 2010

(54) DATA TRANSMISSION CONTROL DEVICE AND DATA TRANSMISSION CONTROL METHOD

(75) Inventors: Akira UENO, Tokyo (JP); Naruyasu Kobayashi, Kawasaki-shi (JP)

Correspondence Address: VOLPE AND KOENIG, P.C., UNITED PLAZA, 30 SOUTH 17TH STREET, PHILADELPHIA, PA, 19103, US

(73) Assignee: OLYMPUS IMAGING CORP., Tokyo (JP)

(21) Appl. No.: 12/815,742

(22) Filed: Jun. 15, 2010

(30) Foreign Application Priority Data
Jun. 22, 2009 (JP) 2009-148064

(51) Int. Cl. G06F 12/06; G06F 12/00

(52) U.S. Cl. 711/5; 711/154; 711/E12.001

(57) ABSTRACT

First and second modules output a predetermined volume of data at a certain rate around the same time. A setting is made so that transfer addresses from the second module are shifted relative to transfer addresses from the first module such that a bank to which the first module issues a data transfer request is in a position separate from a bank to which the second module issues a data transfer request.

### CROSS-REFERENCE TO RELATED APPLICATIONS

This application is based upon and claims the benefit of priority from Japanese Patent Application No. 2009-148064, filed on Jun. 22, 2009, the entire contents of which are incorporated herein by reference.

### BACKGROUND OF THE INVENTION

1. Field of the Invention

The present invention relates to a data transmission control device and a data transmission control method applicable to an electronic equipment such as a digital camera having an SDRAM (synchronous dynamic RAM) as a memory.

2. Description of the Related Art

In recent years, an SDRAM is used not only in personal computers but also in various electronic equipments such as digital cameras. The SDRAM is accessed per data transfer unit called a burst length (e.g., a data length for eight words or four words), so that transfer efficiency is improved. Furthermore, the SDRAM is provided with an address space containing a plurality of banks and is equipped with a function called bank interleaving for sequentially accessing the plurality of banks in a switching manner, so that the transfer efficiency is further improved. This is because it is possible to load an address for a next bank in parallel while data is being transferred to a previously-accessed bank.

### SUMMARY OF THE INVENTION

A data transmission control device according to an aspect of the present invention includes a memory having an address space containing a plurality of banks; a plurality of modules that issue data transfer requests to the memory and output data after transfer acknowledgements are made; and a memory controller that receives the data transfer requests from the modules for the memory and sends signals that acknowledge the requests to the modules, the memory controller controlling access to the banks of the memory on the basis of addresses that are output from the modules when the data transfer requests are issued. A setting is made so that transfer addresses from a module other than a reference module out of the modules, which output a predetermined volume of data at a certain rate around the same time, are shifted relative to transfer addresses from the reference module such that a bank to which the reference module issues a data transfer request is in a position separate from a bank to which the module other than the reference module issues a data transfer request.

A data transmission control method according to another aspect of the present invention uses a data transmission control device that includes a memory having an address space containing a plurality of banks; a plurality of modules that issue data transfer requests to the memory and output data after transfer acknowledgements are made; and a memory controller that receives the data transfer requests from the modules for the memory and sends signals that acknowledge the requests to the modules, and controls access to the banks of the memory on the basis of addresses that are output from the modules when the data transfer requests are issued. The data transmission control method includes making a setting so that transfer addresses from a module other than a reference module out of the modules, which output a predetermined volume of data at a certain rate around the same time, are shifted relative to transfer addresses from the reference module such that a bank to which the reference module issues a data transfer request is in a position separate from a bank to which the module other than the reference module issues a data transfer request.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is schematic block diagram of a configuration example of a data transmission control device of a digital camera;

FIG. 2 is a schematic diagram representing a method of outputting two-line data simultaneously from an imaging unit;

FIG. 3A is a timing chart representing an accessing method in a case where means according to an embodiment are not adopted; and

FIG. 3B is a timing chart representing an accessing method in a case where the means according to the embodiment are adopted.

### DETAILED DESCRIPTION OF THE PREFERRED EMBODIMENTS

Exemplary embodiments of the present invention will be explained below with reference to the accompanying drawings. The embodiments will be explained with an example of a data-access control device mounted on an imaging system such as a digital camera as an electronic equipment.

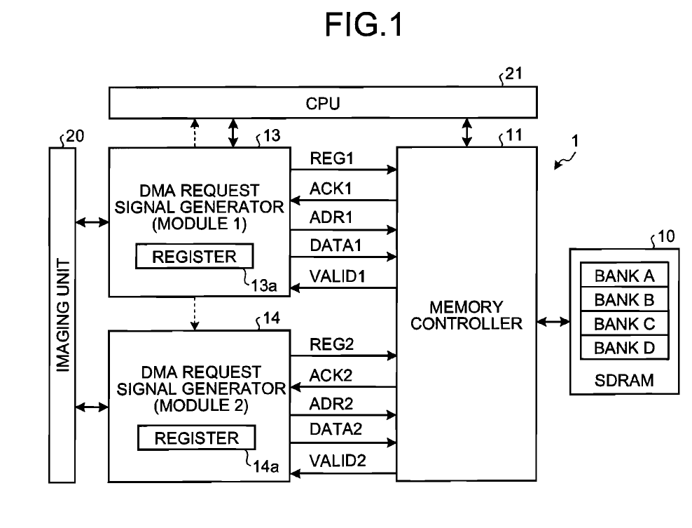

FIG. 1 is a schematic block diagram of a configuration example of a data transmission control device of a digital camera. A data transmission control device 1 according to the embodiment includes an SDRAM 10, a memory controller 11, and two DMA request signal generators 13 and 14.

The SDRAM 10 consists of an address space that includes a plurality of banks, for example, four banks A to D.

The DMA request signal generators 13 and 14 (modules 1 and 2) issue data transfer requests (Reg1 and Reg2) and simultaneously output access addresses (Adr1 and Adr2) to the memory controller 11. The memory controller 11 issues transfer acknowledgements (Ack1 and Ack2) if data transfer can be performed, and then outputs signals indicating that the data is valid (Valid1 and Valid2). The DMA request signal generators 13 and 14 (modules 1 and 2) send transfer data (Data1 and Data2) for writing the data or receive transfer data (Data1 and Data2) for reading the data in accordance with the signals (Valid1 and Valid2). Data that is both transferred from the DMA request signal generators 13 and 14 is image data that is output from an imaging unit 20 (for which a solid imaging device, such as a CCD, is used) and is then output in parallel via two channels. In other words, the DMA request signal generators 13 and 14 output a predetermined volume of data at a certain rate around the same period. There is no order of priority for accessing the SDRAM 10. All accessing has the same high priority.

The memory controller 11 is essentially a bus to which the SDRAM 10 and the DMA request signal generators 13 and 14 are connected. The memory controller 11 receives the data transfer requests (Reg1 and Req2) for the SDRAM 10 from the DMA request signal generators 13 and 14 as request signals Reg. In response to the request signals, the memory controller 11 sends acknowledgement signals Ack (Ack1 and Ack2), which acknowledge the data transfer requests in accordance with the priority level of the requested data access, to the DMA request signal generators 13 and 14. The memory controller 11 controls access to the banks A to D in the SDRAM 10 by interleaving on the basis of transfer addresses that are output from the DMA request signal generators 13 and 14 (the modules 1 and 2) when data transfer requests are issued. The memory controller 11 performs the above-described control, which is independent from a CPU 21 that controls the entire digital camera. The memory controller 11 also performs bus adjustment between the DMA request signal generators 13 and 14 (modules 1 and 2).

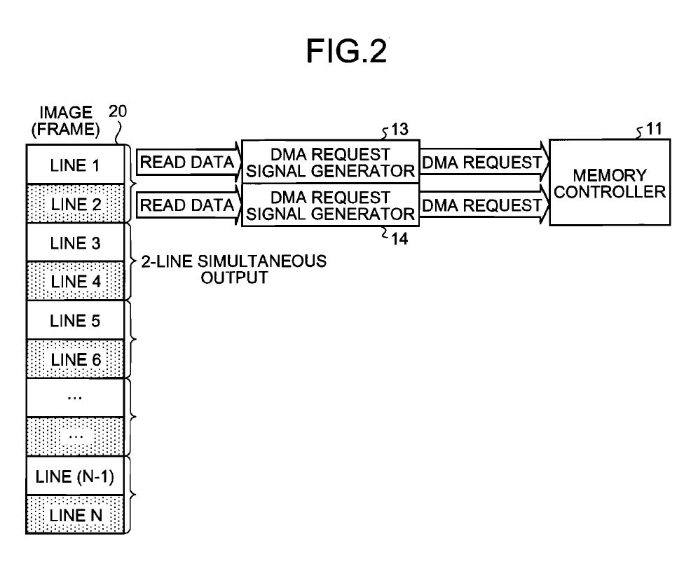

FIG. 2 is a schematic diagram representing a method of simultaneously outputting two-line data from the imaging unit 20. Provided that a frame image, which is captured by the imaging unit 20, consists of N lines 1 to N, the DMA request signal generators 13 and 14 read the data in lines 1 and 2 almost simultaneously. In addition, the DMA request signal generators 13 and 14 output DMA requests almost simultaneously to the SDRAM 10 via the memory controller 11. Such processes are similarly performed on the subsequent lines 3 and 4, the lines 5 and 6, and so on until lines (N−1) and N are reached.

In the embodiment using the two-line data simultaneous outputting method, as illustrated in FIG. 1, the DMA request signal generators 13 and 14 include registers 13a and 14a, respectively, in which the first transfer address and a shift amount of addresses for storing image data line by line, which is referred to as a line skipping amount, are individually set by the CPU 21. The DMA request signal generators 13 and 14 are configured to generate addresses each time a transfer is made from the values set in the registers 13a and 14a. In this case, the DMA request signal generators 13 and 14 refer to the registers 13a and 14a, regard the first transfer address as a starting position, and generate transfer addresses. For transferring data in the second and subsequent lines, a position that is obtained by sequentially adding the line skipping amount to the start position is generated as the first address. In accordance with the first transfer address and the line skip amount, the memory controller 11 performs bank switching by referring to the last few bits (for example, two bits for four banks or three bits for eight banks) of a transfer address. Therefore, the CPU 21 sets the last few bits of the transfer addresses from the DMA request signal generators 13 and 14 to numbers different from each other.

Specifically, if the first transfer address and the line skipping amount are set in the DMA request signal generator 13 such that the address of the bank A is the first transfer address and the transfer addresses of the banks A, B, C, D, A . . . are generated in the sequence they appear in this sentence, the bank to which the DMA request signal generator 13 issues a data transfer request is in a position not adjacent but separate from the bank to which the DMA request signal generator 13 issues a data transfer request. In other words, the first transfer address and the line skipping amount are set in the DMA request signal generator 14 such that the address of the bank C is the first transfer address and the transfer addresses of the banks C, D, A, B, C . . . are generated in the sequence they appear in this sentence. As described, transfer addresses from the DMA request signal generator 14 are shifted by two banks relative to the transfer addresses from the DMA request signal generator 13.

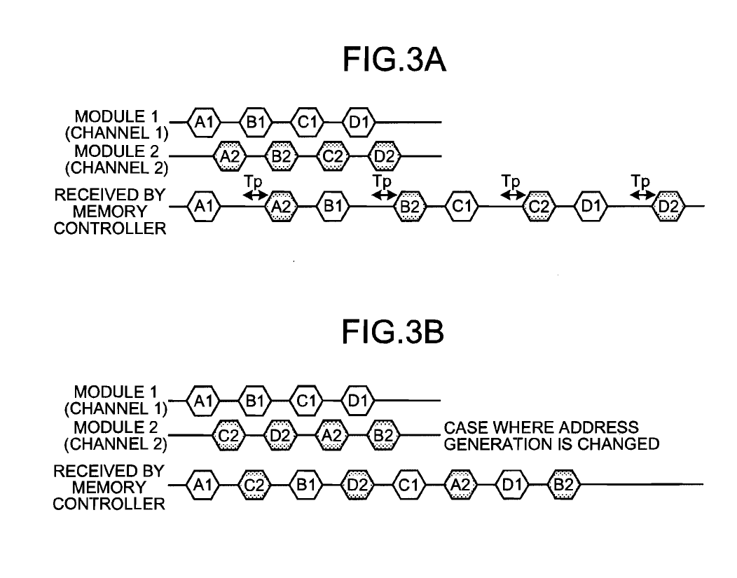

An accessing method with the above configuration using the two-line data simultaneous output will be explained here. FIG. 3A is a timing chart representing an accessing method in a case where the means according to the embodiment are not adopted. A to D represented in FIG. 3A are the banks in the SDRAM. As illustrated in FIG. 3A, transfer requests from the module 1 (the DMA request signal generator 13) corresponding to a first channel are provided with the reference numeral 1 and transfer requests from the module 2 (the DMA request signal generator 14) corresponding to a second channel are provided with the reference numeral 2 (this applies to FIG. 3B).

Regarding access using the two-line data simultaneous output that does not adopt the configuration according to the present invention, addresses to which transfer requests are made from the modules 1 and 2 are the same because of the relation between the image data positions and the addresses. In other words, as illustrated in FIG. 3A, while the transfer addresses from the module 1 are of banks A1, B1, C1, D1 . . . in the sequence they appear in this sentence, the transfer addresses from the module 2 are of banks A2, B2, C2, D2 . . . in the sequence they appear in this sentence. The modules 1 and 2 DMA issues requests almost simultaneously to the memory controller (the module 2 slightly lags behind the module 1 in FIG. 3A).

In this case, because the bank A1 and the bank A2 are the same bank, the memory controller receives the request for the bank A2 after the process in a penalty process time Tp due to a request receiving reprocess. Similarly, the penalty process time Tp is required for subsequent accessing of the same banks B1 and B2, C1 and C2, and D1 and D2. This lowers the transfer efficiency.

In contrast, FIG. 3B is a timing chart representing an accessing method in a case where the means according to the embodiment are adopted. In the embodiment, as illustrated in FIG. 3B, when the transfer addresses from the module 1 are of banks A1, B1, C1, D1 . . . in the sequence they appear in this sentence, a setting is made so that the generation of an address by the module 2 is shifted relative to generation of an address by the module 1. Accordingly, the transfer addresses from the module 2 are of banks C2, D2, A2, B2 . . . in the sequence they appear in this sentence.

In this case, the memory controller 11, which performs bank interleaving, receives requests for the banks A1, C2, B1, D2, C1, A2, D1, B1 . . . in the sequence they appear in this sentence. Therefore, accessing the same bank does not occur.

According to the embodiment, occurrence of a penalty due to accessing the same bank is prevented when data is transferred from the modules 1 and 2 (the DMA request signal generators 13 and 14) for which access to the SDRAM 10 has no order of priority and for which access has high priority. Accordingly, the bank interleaving can be appropriately performed and thus the data transfer efficiency can be improved. In addition, because the information on the transfer addresses is set in the modules 1 and 2, the method can be changed and the number of modules can be easily increased when required.

The present invention is not limited to the above-described embodiment. The present invention can be modified within the scope of the present invention. For example, the transfer addresses are shifted by two banks when four banks are used in the embodiment. Alternatively, they may be shifted by three banks (for example, the sequence may be D, A, B, C, . . . ). However, if the transfer addresses are shifted by three banks, depending on the time at which a transfer request is issued, the same bank may be accessed; therefore, it is preferable that the transfer addresses be shifted by two banks. The number of banks by which the transfer addresses are shifted may be changed according to the number of banks. For example, if the number of banks is eight, the number of addresses by which the transfer addresses are shifted may be two to seven banks. However, because accessing the same bank may occur because of the above reasons, it is preferable that the transfer addresses be shifted by two to six banks. The transfer addresses may also be shifted by one bank. However, this may result in a request for the same bank in the next data transfer.

In the embodiment, the case is exemplified where the data transmission control device is used to output image data from the imaging unit of a digital camera. Alternatively, it may be used to output image data to a liquid crystal display. Furthermore, it may be used in various electric devices, such as mobile phones and digital cameras that include SDRAMs and a plurality of equivalent modules.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data transmission control device comprising:
a memory having an address space containing a plurality of banks;
a plurality of modules that issue data transfer requests to the memory and output data after transfer acknowledgements are made; and
a memory controller that receives the data transfer requests from the modules for the memory and sends signals that acknowledge the requests to the modules, the memory controller controlling access to the banks of the memory on the basis of addresses that are output from the modules when the data transfer requests are issued,
wherein, a setting is made so that transfer addresses from a module other than a reference module out of the modules, which output a predetermined volume of data at a certain rate around the same time, are shifted relative to transfer addresses from the reference module such that a bank to which the reference module issues a data transfer request is in a position separate from a bank to which the module other than the reference module issues a data transfer request.

2. The data transmission control device according to claim 1, wherein the memory controller performs data transfer with the modules, to which acknowledgements for access to the memory are issued, while switching between the banks for the modules.

3. The data transmission control device according to claim 1, wherein data that is transferred from the modules is data that is output from an imaging unit and then output via a plurality of channels around the same time.

4. A data transmission control method using a data transmission control device that includes a memory having an address space containing a plurality of banks; a plurality of modules that issue data transfer requests to the memory and output data after transfer acknowledgements are made; and a memory controller that receives the data transfer requests from the modules for the memory and sends signals that acknowledge the requests to the modules, and controls access to the banks of the memory on the basis of addresses that are output from the modules when the data transfer requests are issued, the data transmission control method comprising:
making a setting so that transfer addresses from a module other than a reference module out of the modules, which output a predetermined volume of data at a certain rate around the same time, are shifted relative to transfer addresses from the reference module such that a bank to which the reference module issues a data transfer request is in a position separate from a bank to which the module other than the reference module issues a data transfer request.
